(19) United States
(12) Patent Application Publication
(10) Pub. No.: US 2004/0146383 A1
(43) Pub. Date: Jul. 29, 2004

(54) Apparatus having a variable pitch pick-and-place head for packaging electrical parts and methods of operating the same

(75) Inventor: Merlin E. Behnke, Grafton, WI (US)

Correspondence Address: MICHAEL BEST & FRIEDRICH, LLP, 100 E WISCONSIN AVENUE, MILWAUKEE, WI, 53202, US

(73) Assignee: International Product Technology, Inc., New Berlin, WI (US)

(21) Appl. No.: 10/756,487

(22) Filed: Jan. 13, 2004

Related U.S. Application Data
(60) Provisional application No. 60/439,869, filed on Jan. 14, 2003.

(51) Int. Cl. B65G 65/04

(52) U.S. Cl. 414/416.02; 414/749.5; 414/752.1

(57) ABSTRACT

An apparatus including a pick-and-place apparatus and methods of operating a pick-and-place apparatus. The pick-and-place apparatus includes a frame, a plurality of vacuum rails movable in the frame, a row of vacuum nozzles on each vacuum rail, a plurality of stop members, a first mechanism for biasing the vacuum rails apart, toward, and into engagement with the stop members, and a second mechanism for biasing the vacuum rails together. The vacuum rails have a maximum pitch, in which the vacuum rails are biased apart by the first mechanism and engage the stop members, and a minimum pitch, in which the second mechanism overcomes the bias of the first mechanism and biases the vacuum rails together. The pick-and-place apparatus can pick up a two dimensional array of electrical parts, change spacing between the electrical parts, rotate the two-dimension array of electrical parts and place the parts in carrier tape.

### RELATED APPLICATION

This application claims the benefit of co-pending U.S. Provisional Patent Application No. 60/439,869 filed Jan. 14, 2003.

### FIELD OF THE INVENTION

The present invention relates to apparatuses for packing electrical parts and, more particularly, to apparatuses having a variable pitch pick-and-place head for packing electrical parts and methods of operating the apparatuses.

### BACKGROUND OF THE INVENTION

A variety of packaging apparatuses are used to package electrical parts such as electronic computer chips, microprocessors, and the like. Such packaging apparatuses include part heads for picking up the electrical parts from an electrical part tray and placing the electrical parts in carrier tape or some other packaging device. The packaging apparatuses also include a linear actuator for linearly moving the part head between the tray and the carrier tape. Typically, the part heads are vacuum operated and include a vacuum nozzle.

### SUMMARY OF THE INVENTION

In some aspects, the invention provides a pick-and-place apparatus including a frame, a plurality of vacuum rails adapted for communication with a source of vacuum, the rails being movable in the frame with respect to each other; a row of vacuum nozzles on each vacuum rail, the space between nozzles on the same vacuum rail defines a first pitch and the space between nozzles on different vacuum rails defines a second pitch that is adjustable between maximum and minimum settings by moving the vacuum rails with respect to each other, a first mechanism for moving the vacuum rails apart toward a maximum second pitch, and a second mechanism for moving the vacuum rails toward a minimum second pitch.

In some aspects, the invention provides an apparatus for packaging electrical parts, the apparatus including a pick-and-place head including a frame, a plurality of vacuum rails movable in the frame with respect to each other and adapted for communication with a source of vacuum, and a row of vacuum nozzles on each vacuum rail. The space between nozzles on the same vacuum rail defines a first pitch and the space between nozzles on different vacuum rails defines a second pitch that is adjustable between a maximum second pitch and a minimum second pitch by moving the vacuum rails with respect to each other. The apparatus also includes a rotatable coupling engagable with the pick-and-place head to rotate the pick-and-place head and an actuator operably connected to the pick-and-place head to move the pick-and-place head between a picking position, in which the pick-and-place head picks up electrical parts from a first electrical part support, and a placing position, in which the pick-and-place head places electrical parts in a second electrical part support. The pick-and-place head is rotatable by the rotatable coupling between the picking position and the placing position.

In some aspects, the invention provides a method of operating a pick-and-place apparatus, the method including picking up a two-dimensional array of electrical parts from a first electrical part support with the pick-and-place apparatus, the two-dimensional array of electrical parts being arranged in rows and columns, changing spacing between the rows, and placing the electrical parts in a second electrical part support one column at a time.

In some aspects, the present invention provides a method of operating a pick-and-place apparatus, the method including providing the pick-and-place apparatus that includes a plurality of vacuum rails movable relative to each other and adapted for communication with a source of vacuum and a row of vacuum nozzles that are on each vacuum rail. The space between nozzles on the same vacuum rail defines a first pitch and the space between nozzles on different vacuum rails defines a second pitch that is adjustable between maximum and minimum settings by moving the vacuum rails with respect to each other. The method further includes picking up a two-dimensional array of electrical parts with the vacuum nozzles of the pick-and-place apparatus from a first electrical part support, adjusting the second pitch of the vacuum rails, rotating the pick-and-place apparatus and the two-dimensional array of electrical parts, and placing the electrical parts in a second electrical part support.

### BRIEF DESCRIPTION OF THE DRAWINGS

FIG. 1 is schematical top view of an apparatus embodying aspects of the present invention.

FIG. 2 is a partial side view of a portion of the apparatus illustrated in FIG. 1.

FIG. 3 is a bottom perspective view of a pick-and-place head of the apparatus shown in FIG. 1.

FIG. 4 is a side view of the pick-and-place head shown in FIG. 3.

FIG. 5 is a front view of the pick-and-place head shown in FIG. 3.

FIG. 6 is a bottom view of the pick-and-place head shown in FIG. 3, shown with a portion of the pick-and-place head removed and in a maximum pitch.

FIG. 7 is cross-sectional view taken along line 7-7 in FIG. 6.

FIG. 8 is a bottom view of the pick-and-place head, shown with a portion of the pick-and-place head removed and in a minimum pitch.

FIG. 9 is a cross-sectional view taken along line 9-9 in FIG. 8.

FIG. 10 is a partial cross-sectional view taken along line 10-10 in FIG. 6.

FIG. 11 is a side view of a side wall of the pick-and-place head shown in FIG. 3, shown with a portion of the side wall removed.

FIG. 12 is side view of a vacuum mounting plate of the pick-and-place head shown in FIG. 3.

FIG. 13 is an exploded rear perspective view of a solenoid of the pick-and-place head shown in FIG. 3 and a portion of the side wall shown in FIG. 11.

FIG. 14 is a partial side view of the side wall shown in FIG. 11 and a schematical portion of the solenoid shown in FIG. 13.

FIG. 15 a front perspective view of an alternative construction of a vacuum mounting plate of the pick-and-place head shown in FIG. 3.

FIG. 16 is a schematical top view of an alternative construction of a portion of an apparatus embodying aspects of the present invention.

Before at least one embodiment of the invention is explained in detail, it is to be understood that the invention is not limited in its application to the details of construction and the arrangements of the components set forth in the following description or illustrated in the drawings. The invention is capable of other embodiments and of being practiced or being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and variations thereof herein are used broadly and encompass direct and indirect connections and couplings. In addition, the terms “connected” and “coupled” and variations thereof are not restricted to physical or mechanical connections or couplings.

### DETAILED DESCRIPTION OF THE PREFERRED EMBODIMENT

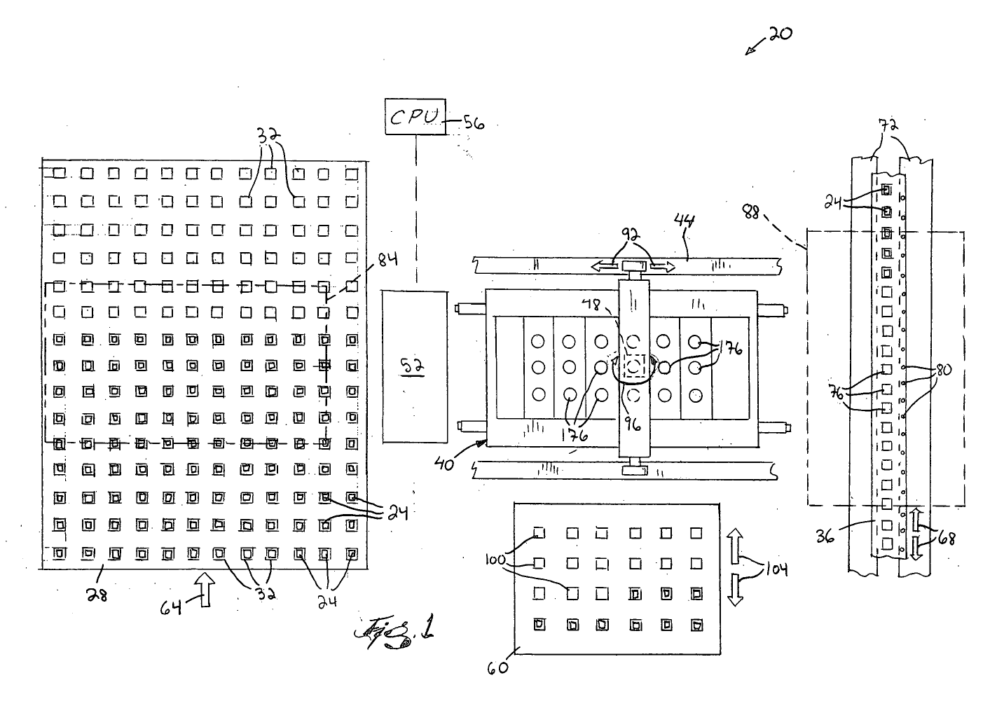

FIG. 1 illustrates an apparatus 20 for packaging electrical parts 24, such as, for example electronic computer chips, microprocessors, and the like. The apparatus 20 includes an input tray 28 having a plurality of compartments 32 for supporting the electrical parts 24 therein, carrier tape 36, a pick-and-place apparatus or head (PNP head) 40 that picks up electrical parts 24 from the input tray 28 and places the electrical parts 24 in the carrier tape 36, a linear actuator 44 operable to move the PNP head 40 between the input tray 28 and the carrier tape 36, a rotatable or pivotal coupling 48 connected between the PNP head 40 and the linear actuator 44 to rotate and vertically move the PNP head 40, a scanner 52 for scanning electrical parts 24, a central processing unit (CPU) 56 communicating with and controlling components and aspects of the apparatus 20, and a reject tray 60 for supporting unacceptable electrical parts 24 that have been identified as unacceptable by the scanner 52 and CPU 56.

The input tray 28 moves longitudinally along a path 64 to introduce the electrical parts 24 into the apparatus 20 and the carrier tape 36 moves longitudinally along a path 68 to export parts 24 out of the apparatus 20. The input tray 28 can move along the path 64 in many manners, such as, for example a conveyor system or the like. Guide rails 72 are disposed underneath flanges of the carrier tape 36 to vertically and laterally support the carrier tape 36 as it moves along the path 68. The carrier tape 36 also includes a plurality of linearly-disposed compartments 76 that support the electrical parts 24 therein and a plurality of sprocket holes 80 defined in one of the flanges. The sprocket holes 80 can be engaged by a drive system (not shown) that drives the carrier tape 36 along the path 68. Movement of the input tray 28 and carrier tape 36 is not meant to be limited by the paths 64, 68, respectively, and may move along other paths and in many directions, such as laterally, vertically, and diagonally and still be within the spirit and scope of the present invention. In addition, a tray or other type of packaging device may be substituted in place of the carrier tape 36 and still be within the spirit and scope of the present invention.

The linear actuator 44 and the pivotal coupling 48 move the PNP head 40 between a picking position (shown in phantom) 84 and a placing position (shown in phantom) 88. The linear actuator 44 moves the PNP head 40 laterally as indicated by arrows 92 and the pivotal coupling 48 rotates the PNP head 40 as indicated by arrow 96. The picking position 84 is generally positioned over the input tray 28 and the placing position 88 is generally positioned over the carrier tape 36. As discussed herein, the movement of the PNP head 40 is for illustrative purposes only and should not be considered limiting. Therefore, the PNP head 40 can move in many manners and in many directions, such as, for example rotatively, vertically, and diagonally and still be within the spirit and scope of the present invention.

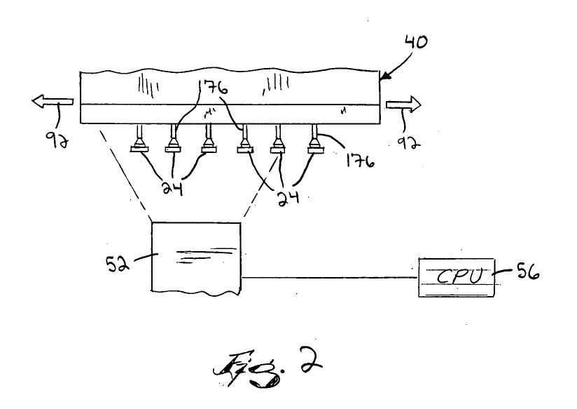

With reference to FIGS. 1 and 2, when in the picking position 84, the PNP head 40 picks up a row-and-column array or matrix of electrical parts 24 from the input tray 28. All of the parts 24 in the row-and-column matrix are picked up simultaneously. For larger parts 24, the matrix may include all adjacent parts 24 under the PNP head 40. However, for very small parts 24, the physical constraints of the vacuum nozzles may require picking up every other or every third part 24 from the rows of the input tray 28.

After picking up the electrical parts 24, the PNP head 40 passes over the scanner 52 between the picking and placing positions 84, 88. The scanner 52 scans the electrical parts 24 either on-the-fly or with the PNP head 40 held stationary over the scanner 52 to determine if any of the electrical parts 24 are missing or unacceptable. The CPU is aware of the positioning of the electrical parts 24 in the input tray 28 and is aware of which vacuum nozzles 176 (as discussed below) should have an electrical part 24 vacuumly connected thereto. Occasionally, some of the electrical parts are missing or are misplaced in the input tray 28. In these instances, the CPU 56 takes the missing parts into consideration when populating the carrier tape 36 with the electrical parts 24 (as discussed below). Occasionally, unacceptable electrical parts are placed into the input tray 28. In these instances, the scanner 52 identifies the unacceptable electrical parts and sends a signal to the CPU 56. The CPU 56 recognizes which electrical parts 24 are unacceptable and affects operation of the apparatus 20 accordingly (as discussed below).

Referring back to FIG. 1, the reject tray 60 includes a plurality of compartments 100 for supporting unacceptable electrical parts 24. The reject tray 60 is operatively connected to the CPU 56 and can move along a path 104 to position itself under the PNP head 40 to receive the unacceptable electrical parts 24 in the compartments 100 thereof. Movement of the reject tray 60 is not meant to be limited by the path 104. Accordingly, the reject tray 60 can move in many manners and in many directions, such as, for example rotatively, vertically, and diagonally and still be within the spirit and scope of the present invention. Also, the reject tray 60 does not necessarily have to move. In such an instance, the PNP head 40 may move in multiple directions to place the unacceptable electrical parts 24 into the compartments 100 of the reject tray 60 or the reject tray 60 can be positioned directly under the PNP head 40 as the PNP head 40 moves along path 92.

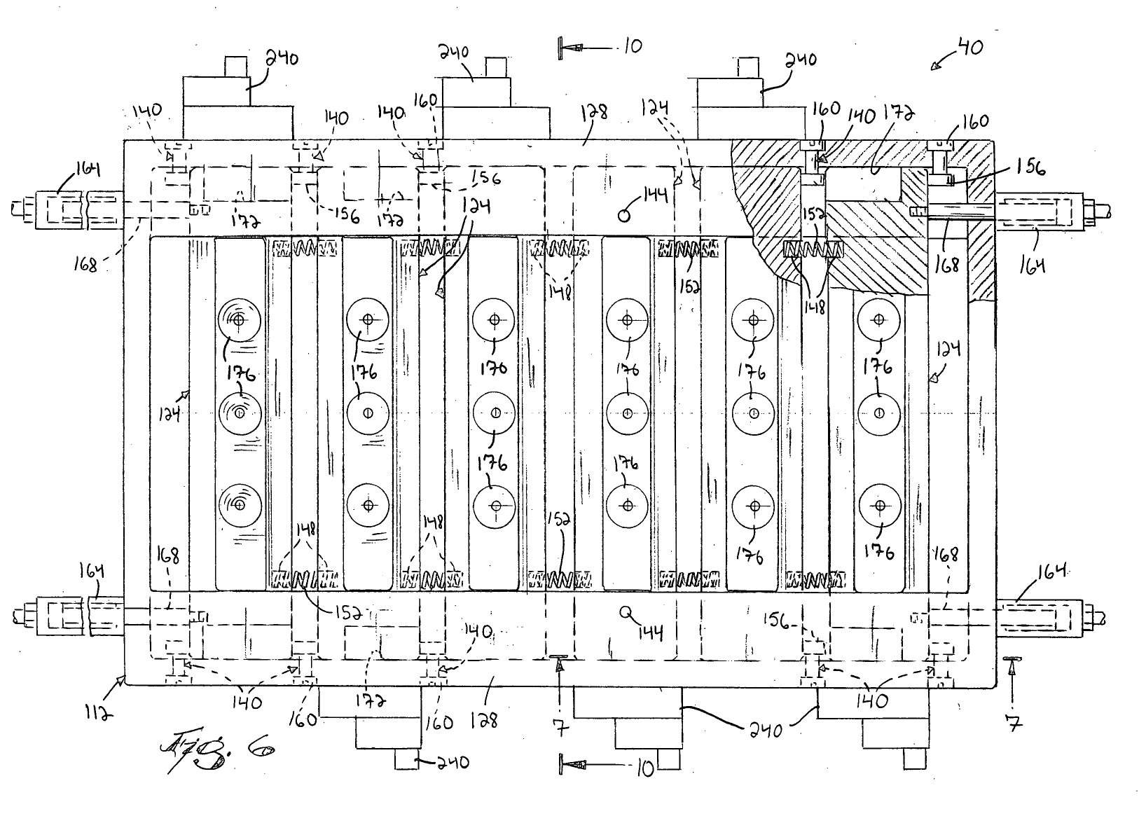

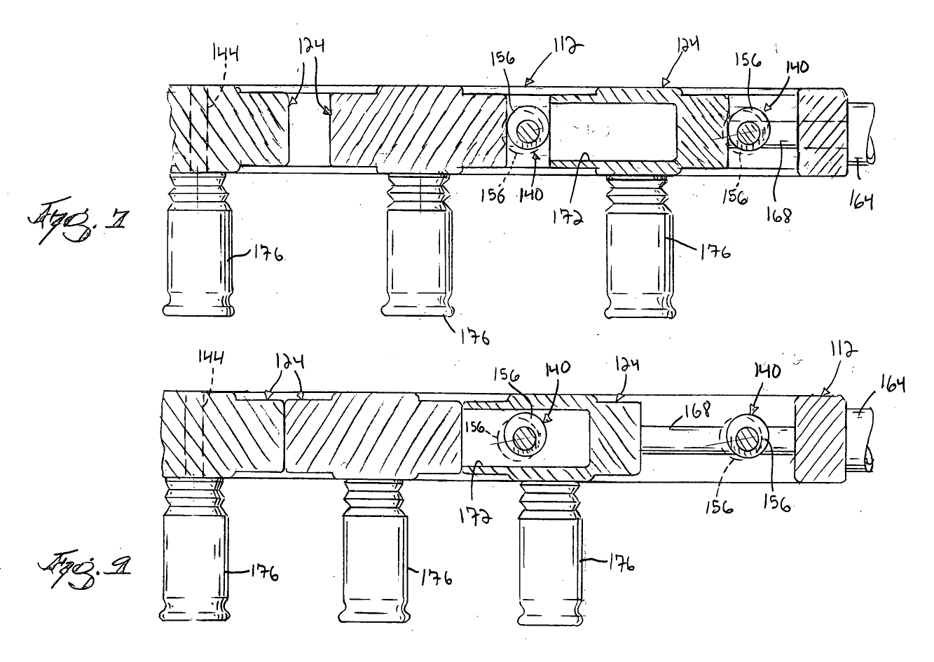

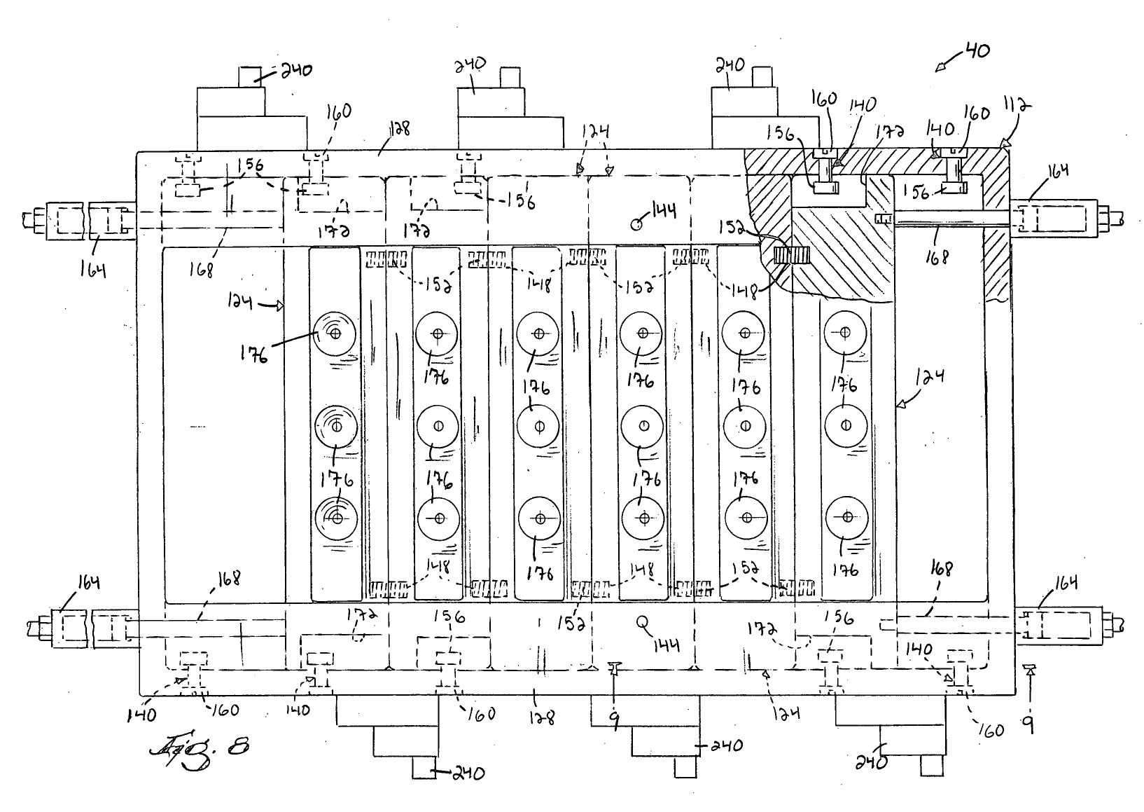

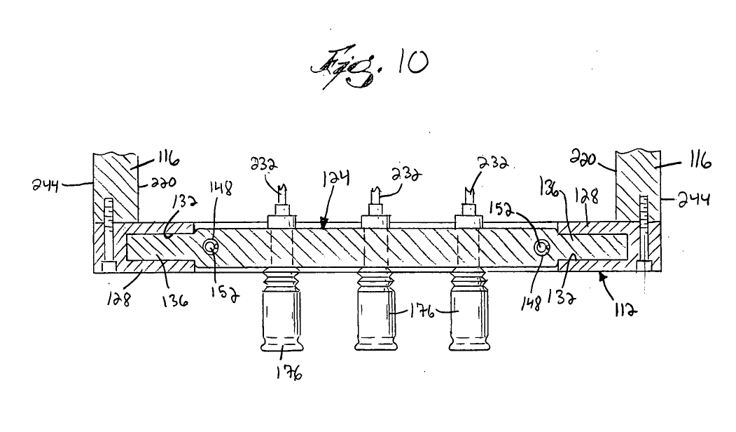

Referring to FIGS. 1-10, the PNP head 40 includes a frame 106 having a top wall 108, a base 112, and side walls or manifolds 116. A connecting rod 120 is mounted to the top wall 108 of the PNP head 40 and is engagable with the pivotal coupling 48 to connect the PNP head 40 to the pivotal coupling 48. The PNP head 40 also includes a plurality of vacuum rails 124 supported by C-shaped guide rails 128 (see FIG. 10). The guide rails 128 form a portion of the base 112 and define a slot or channel 132 therein. The vacuum rails 124 extend between the guide rails 128 and include projections 136 supported within the channels 132. The vacuum rails 124 are slidable along the guide rails 128 between a maximum pitch (shown in FIGS. 6 and 7), in which the vacuum rails 124 are separated from one another and abut a plurality of stop members or pins 140, and a minimum pitch (shown in FIGS. 8 and 9), in which the vacuum rails 124 abut one another. In the illustrated embodiment, the PNP head 40 includes six vacuum rails 124, however, the PNP head 40 can include any number of vacuum rails 124 and still be within the spirit and scope of the present invention.

With reference to FIGS. 6 and 7, one of the vacuum rails 124 is fixed to the guide rails 128 by fixing pins 144. This fixed vacuum rail 124 determines the position of the minimum pitch within the PNP head 40. The fixing pins 144 are driven through the respective guide rail 128 and projection 136 of the vacuum rail 124. Each vacuum rail 124 includes spring cavities 148 defined therein for receiving an end of a compression spring 152. The springs 152 are disposed between the vacuum rails 124 and bias the vacuum rails 124 toward the maximum pitch. In the illustrated embodiment, two compression springs 152 are mounted between adjacent vacuum rails 124, however, any number of compression springs 152 or other biasing members can be mounted between adjacent vacuum rails 124. It should be understood that other devices can be used to move the vacuum rails 124 to the maximum pitch, such as, for example pneumatic devices and camming devices. Such pneumatic devices can be positioned between the vacuum rails 124 to push or to pull the vacuum rails 124 outward toward the maximum pitch. Such camming devices can be indirectly coupled or directly coupled to the vacuum rails 124 to move the vacuum rails 124 outward to the maximum pitch.

The plurality of pins 140 are set in the guide rails 128 and limit the travel of the vacuum rails 124 toward the maximum pitch. The pins 140 are rotatable and include an eccentric engaging portion 156 and a manipulating portion 160. The engaging portion 156 engages a rear portion of a respective vacuum rail 124 when the vacuum rail 124 is biased outwardly by the springs 152. In the illustrated embodiment, the manipulating portion 160 is rotatable by an operator to rotate the eccentric pins 140 and position varying thicknesses of the engaging portion 156 in the path of the vacuum rail. This rotation makes small adjustments to the stopping position of the vacuum rail 124 (the maximum pitch) to align the vacuum nozzles 176 with the electrical parts 24 in the input tray 28. FIG. 7 illustrates several stopping positions in solid lines and in phantom. It should be understood that the pins 140 can be manipulated in other manners such as electronically, pneumatically, etc. and still be within the spirit and scope of the present invention. It should also be understood that other devices can be used in place of the pins 140 to adjust the maximum pitch of the vacuum rails 124, such as, for example stepped members, pneumatic members, etc. and can be adjusted in a variety of manners, such as, for example linearly sliding, rotating, etc., and still be within the spirit and scope of the present invention.

With reference to FIGS. 8 and 9, the vacuum rails 124 are illustrated in the minimum pitch. A plurality of actuating mechanisms 164 are operatively connected to the vacuum rails 124 to selectively overcome the bias of the compression springs 152 and move the vacuum rails 124 to the minimum pitch. In the illustrated embodiment, the actuating mechanisms 164 are pneumatical cylinders and include pistons 168 that engage a surface of the outermost vacuum rails 124. The pistons 168 are moveable between an extended position and a retracted position that correspond to the minimum pitch and maximum pitch, respectively, of the vacuum rails 124.

The vacuum rails 124 not adjacent to the fixed vacuum rail 124 include a pin cavity 172 for receiving one of the plurality of pins 140 therein when the vacuum rails 124 are moved to the minimum pitch by the actuating mechanisms 164. The cavities 172 prevent the pins 140 from interfering with movement of the vacuum rails 124 toward the minimum pitch. The vacuum rails 124 stop upon abutting one another and the width of the rails 124 determines the position of the vacuum nozzles 176 in the minimum pitch. The vacuum rails 124 adjacent the fixed vacuum rail 124 do not require cavities 172 because the fixed vacuum rail 124 does not move and pins 140 are therefore not required to limit its movement.

Referring again to FIGS. 1-10, a plurality of vacuum nozzles 176 are connected to the vacuum rails 124 in a generally two-dimensional array arranged in rows and columns. Each vacuum rail 124 defines a row of vacuum nozzles 176 and corresponding vacuum nozzles 176 in different vacuum rails 124 define a column of vacuum nozzles 176. The space or pitch between the vacuum nozzles 176 on the same vacuum rail 124 does not change and the spacing or pitch between the corresponding vacuum nozzles 176 on different vacuum rails 124 changes according to movement of the vacuum rails 124 with respect to one another. The vacuum nozzles 176 are operable to pick up the electrical parts 24 by using vacuum and place the electrical parts 24 by using low pressure air or no air at all (as discussed below). In the illustrated embodiment, three vacuum nozzles 176 are connected to each vacuum rail 124, however, any number of vacuum nozzles 176 can be connected to the vacuum rails 124.

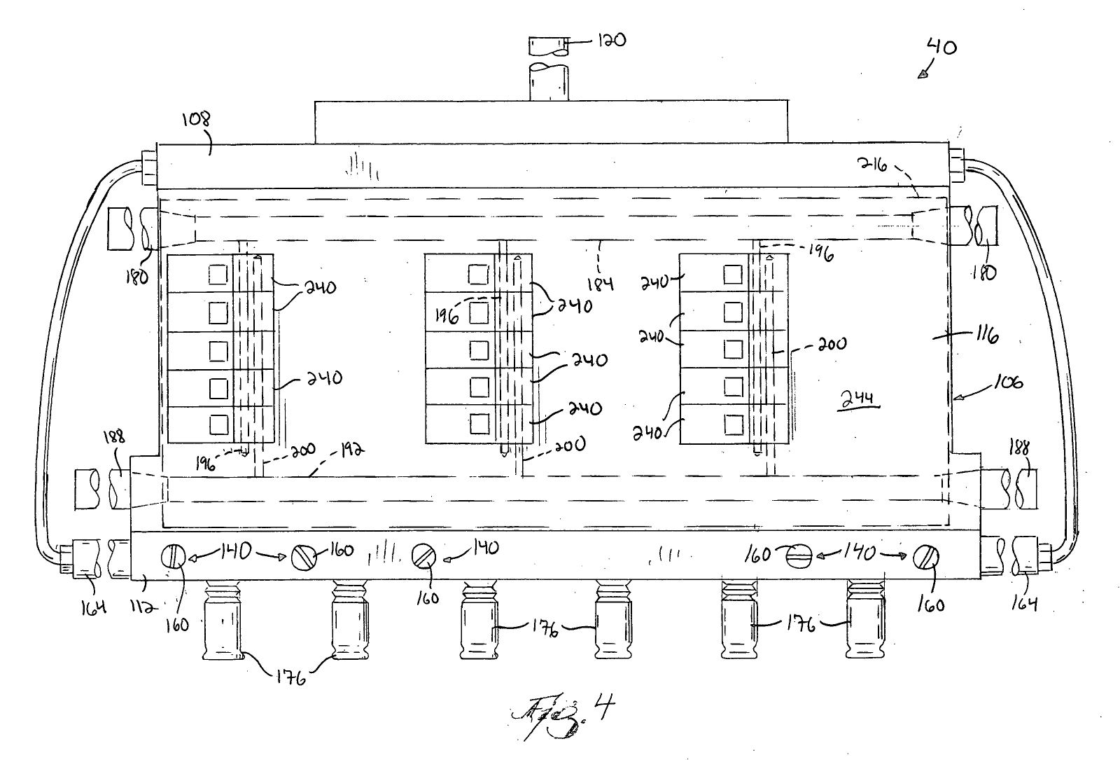

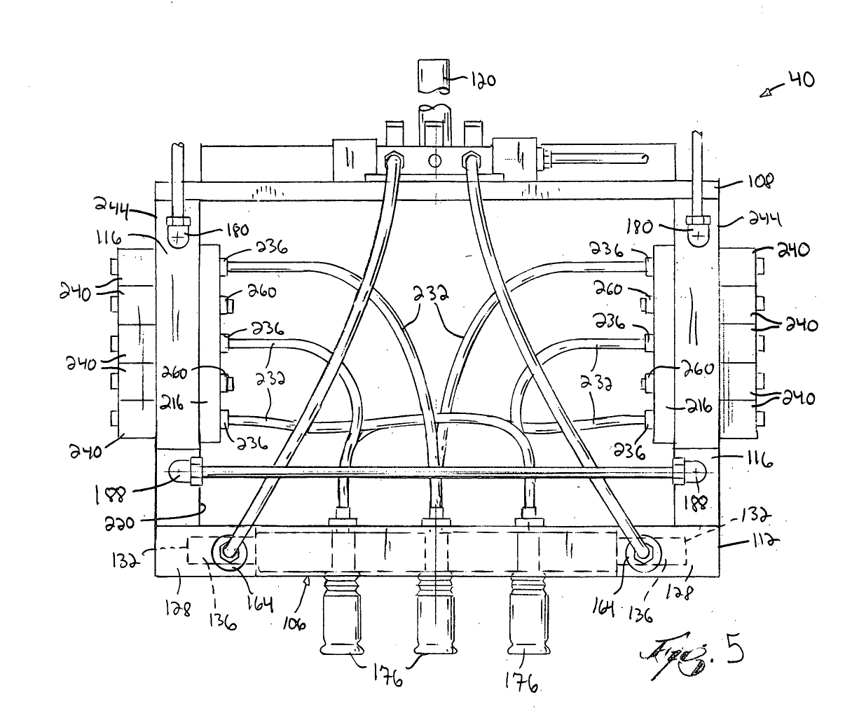

Referring to FIGS. 4 and 5, vacuum is supplied to the PNP head 40 via vacuum supply tubes 180 connected to vacuum supply channels 184 defined in the side walls 116 of the PNP head 40. Low pressure air is supplied to the PNP head 40 via air supply tubes 188 connected to air supply channels 192 defined in the side walls 116.

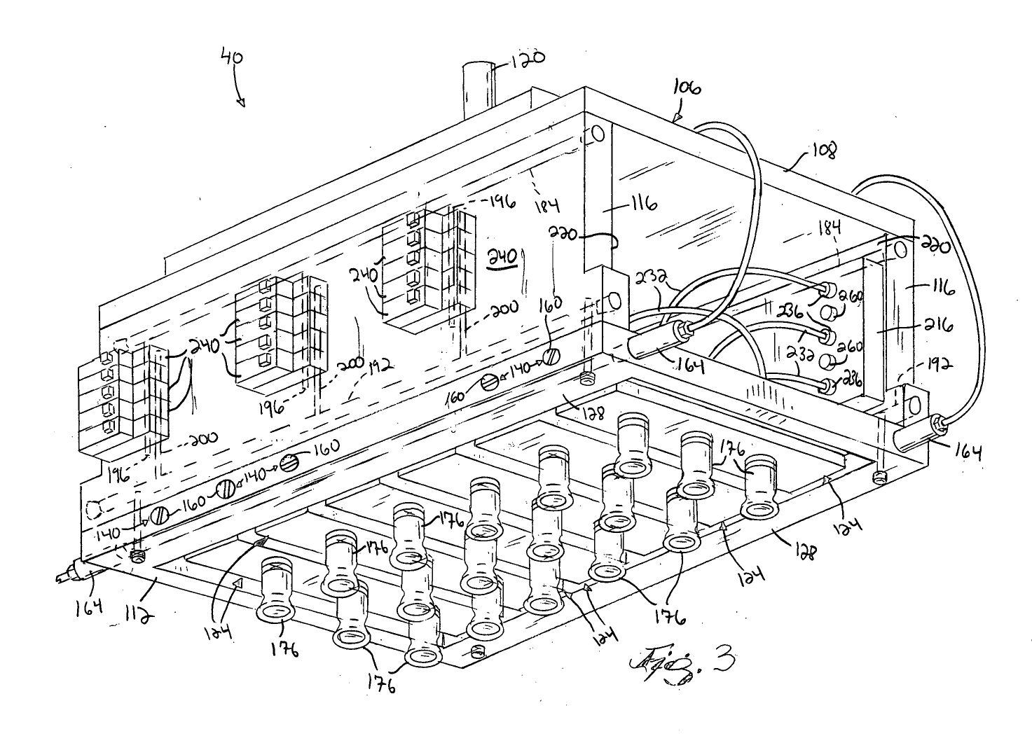

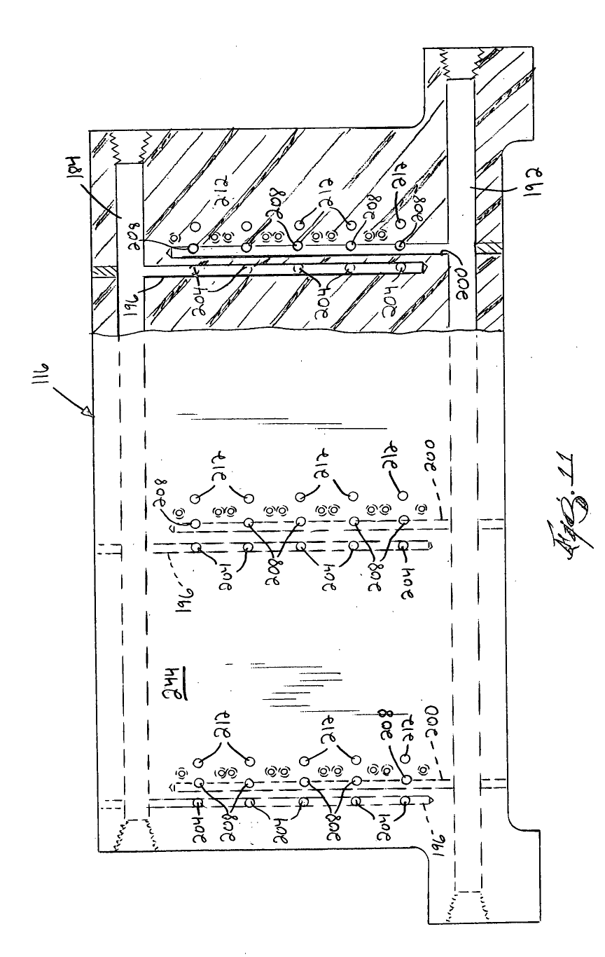

Referring to FIGS. 3-5 and 11, the side walls 116 also include a plurality of vertical vacuum channels 196 defined therein and a plurality of vertical air channels 200 defined therein. The vertical vacuum channels 196 and the vertical air channels 200 are in fluid communication with the vacuum supply channels 184 and the air supply channels 192, respectively. A plurality of vacuum apertures 204 are defined in the side walls 116 and are in fluid communication with the vertical vacuum channels 196. A plurality of low pressure air apertures 208 are also defined in the side walls 116 and are in fluid communication with the vertical air channels 200. A plurality of supply apertures 212 are further defined in the side walls 116 and extend entirely through the side walls 116. In the illustrated embodiment, each side wall 116 includes fifteen sets of vacuum, air, and supply apertures 204, 208, 212 (thirty sets total including both side walls), however, any number of sets of apertures 204, 208, 212 can be defined in the side walls 116.

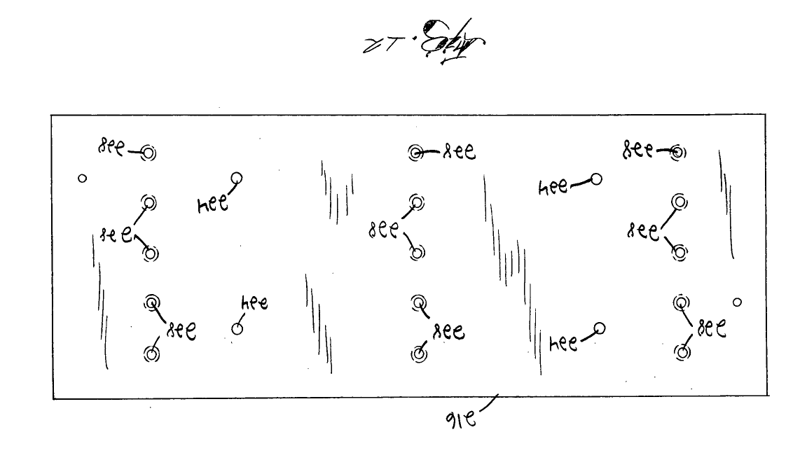

Referring to FIGS. 3-5 and 12, the PNP head 40 also includes a vacuum mounting plate or template 216 mountable to an interior side 220 of each side wall 116. Each vacuum mounting plate 216 includes a plurality of mounting apertures 224 defined therethrough through which fasteners are insertable to connect the vacuum mounting plate 216 to the side wall 116. The vacuum mounting plate 216 also includes a plurality of apertures 228 that align with and are in fluid communication with the supply apertures 212 defined in the side wall 116 when the vacuum mounting plate 216 is mounted to the side wall 116. In the illustrated embodiment, the vacuum mounting plate 216 defines the same number of apertures 228 as supply apertures 212 defined in the side wall 116. It should be understood that the mounting plate 216 can define any number of apertures 228 therethrough and can define a different amount of apertures 228 than supply apertures 212 and still be within the spirit and scope of the present invention. In cases where there are more supply apertures 212 than apertures 228, the vacuum mounting plate 216 covers the supply apertures 212 in excess of and not aligned with the apertures 228 to prevent vacuum and/or air from escaping the excess supply apertures 212. Side walls 116 defining supply apertures 212 in excess of vacuum mounting plate apertures 228 can accommodate vacuum mounting plates 216 having more apertures 228 defined therethrough (as discussed below).

Referring again to FIGS. 3 and 5, the PNP head 40 further includes a plurality of air tubes 232. Each air tube 232 is connected to one of the vacuum nozzles 176 at one end thereof and is connected to the vacuum mounting plate 216 via an air tube coupling 236 at another end thereof. The air tube coupling 236 is connectable to one of the apertures 228 in the vacuum mounting plate 216 to fluidly connect the vacuum nozzle 176 with the aperture 228 via the air tube 232.

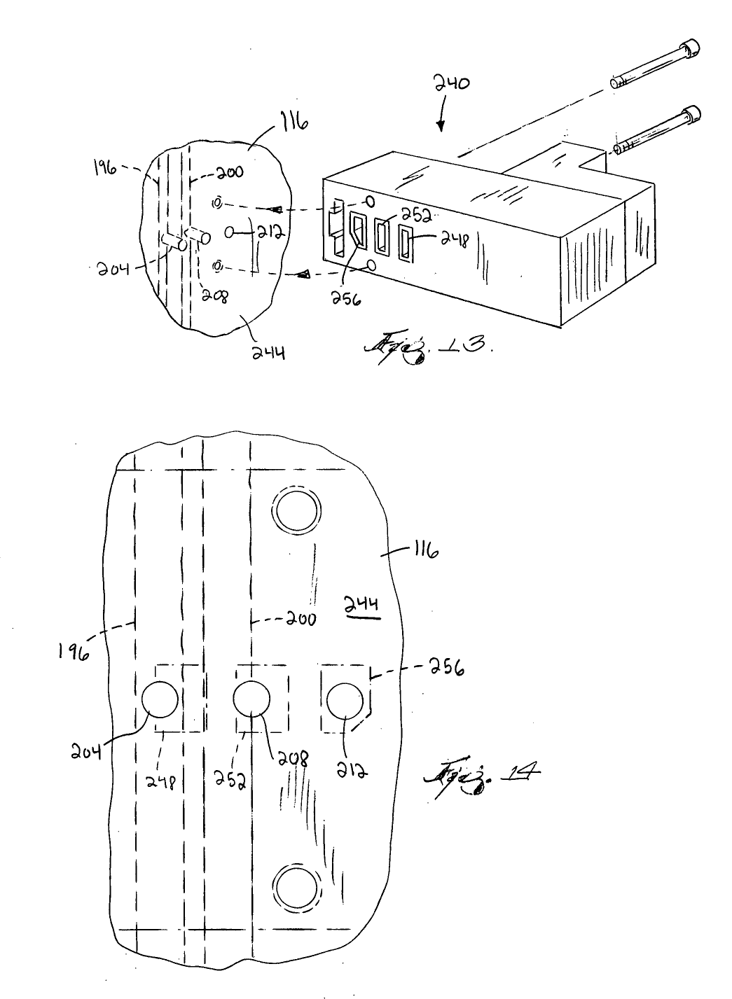

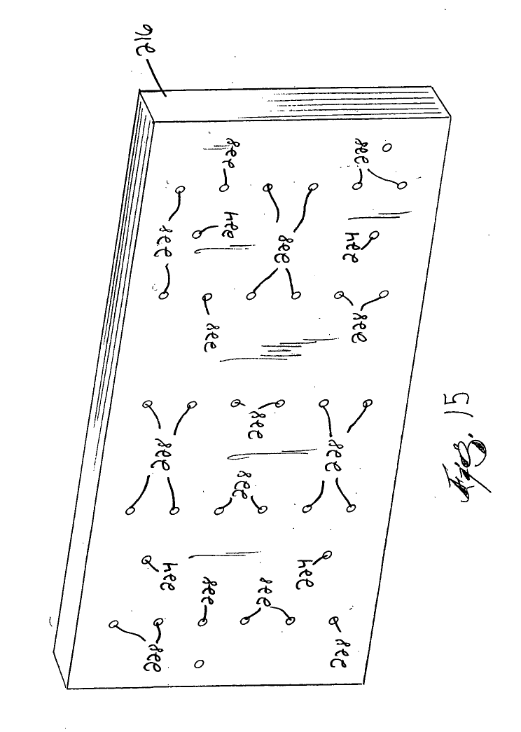

Referring to FIGS. 3-5, 13, and 14, a plurality of solenoids 240 are mounted to an exterior side 244 of each side wall 116. The solenoids 240 are electrically connected to the CPU 56 and controllable thereby. Each solenoid 240 operates with one of the vacuum nozzles 176 to selectively provide vacuum, low pressure, or no air at all to the vacuum nozzle 176. In the illustrated embodiment, more solenoids 240 are illustrated than the number of vacuum nozzles 176. Accordingly, some of the solenoids 240 are unused and the PNP head 40 is capable of including more vacuum nozzles 176 therewith.

Each solenoid 240 includes a vacuum port 248, a low pressure air port 252, and a supply port 256. When the solenoid 240 is mounted to the side wall 116, the vacuum port 248 aligns with and is in fluid communication with one of the vacuum apertures 204 defined in the side wall 116, the low pressure air port 252 aligns with and is in fluid communication with one of the low pressure apertures 208 defined in the side wall 116, and the supply port 256 aligns with and is in fluid communication with one of the supply apertures 212 defined in the side wall 116. The solenoid 240 fluidly connects either the vacuum port 248 or the low pressure air port 252 with the supply port 256 to supply either vacuum or low pressure, respectively, to the vacuum nozzle 176 via the respective aperture 228 defined in the vacuum mounting plate 216, the respective air tube coupling 236, and the respective air tube 232.

In the illustrated embodiment, each vacuum mounting plate 216 includes fifteen apertures 228 therefore providing thirty apertures 228 to which vacuum nozzles 176 can connect via air tubes 232 and air tube couplings 236. Plugs 260 are threaded or otherwise inserted into the vacant apertures 228 to prevent vacuum and low pressure air from escaping through the vacant apertures 228. The PNP head 40 in the illustrated embodiment includes eighteen vacuum nozzles 176 therefore leaving twelve apertures 228 that are not connected to vacuum nozzles 176. If desired, the PNP head 40 could include up to twelve additional vacuum nozzles 176 in the illustrated embodiment.

Also in the illustrated embodiment, the PNP head 40 includes thirty solenoids 240 (fifteen mounted to each side wall 116) and the side walls 116 include 30 sets of vacuum apertures 204, low pressure air apertures 208, and supply apertures 212 (fifteen defined in each side wall 116) that correspond to the thirty apertures 228 in the vacuum mounting plates 216. In the illustrated embodiment, the PNP head 40 includes the same number of solenoids 240 and sets of apertures 204, 208, 212 as apertures 228 defined in the vacuum mounting plates 216. It should be understood that the number of solenoids 240 and apertures 228 does not have to be the same.

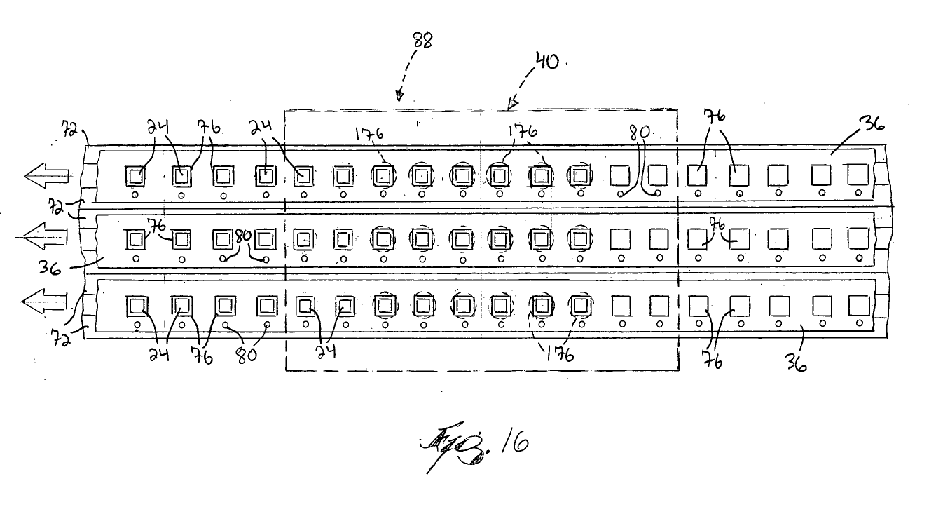

Referring to FIGS. 3 and 15, components of the PNP head 40 can be part of a modular changeout assembly or package. Specifically, the mounting plates 216, air tubes 232, air tube couplings 236, and vacuum rails 124 in the embodiments discussed above are interchangeable with other vacuum mounting plates 216, air tubes 232, air tube couplings 236, and vacuum rails 124, respectively. More specifically, the vacuum mounting plates 216 can have varying numbers of sets of apertures 228 (see FIG. 15) defined therein to accommodate vacuum rails 124 having varying numbers of vacuum nozzles 176 connected thereto. This interchangeability allows the PNP head 40 to accommodate varying numbers of vacuum nozzles 176, which allows the PNP head 40 to pick up varying numbers and varying two-dimensional arrays of electrical parts 24. It should be understood that the base 112 and guide rails 128 can either accommodate varying types of vacuum rails 124 (in other words, the base 112 and the guide rails 128 are not interchanged when the other components are interchanged) or the base 112 and guide rails 128 are interchangeable with the vacuum mounting plates 216, air tubes 232, air tube couplings 236, and vacuum rails 124. In such cases where the base 112 and the guide rails 128 are interchangeable along with the other components of the PNP head 40, the base 112 and the guide rails 128 would be part of the modular changeout assembly.

Now that the components of the apparatus 20 have been described, operation of the apparatus 20 will be described hereinafter relating to packaging of the electrical parts 24. Referring back to FIG. 1, the input tray 28 introduces the electrical parts 24 into the apparatus 20 by moving along the path 64. The PNP head 40 moves laterally over the input tray 28 and moves downward toward the tray 28 to the picking position 84. In the picking position 84, the vacuum nozzles 176 are in the maximum pitch in order to match the spacing between the compartments 32 of the input tray 28. Upon the first cycle of operation, the plurality of pins 140 can be rotated to finely adjust the maximum pitch of the vacuum rails 124 and match the spacing between vacuum rails 124 with the spacing between the compartments 32 of the input tray 28.

Next, the CPU 56 sends a signal to the solenoids 240 to fluidly connect the vacuum ports 248 and the supply ports 256 which fluidly connects the vacuum supply channel 184 to the vacuum nozzles 176 to enable the nozzles 176 to pick up the electric parts 24 with vacuum. After picking up the electrical parts 24, the PNP head 40 moves vertically upward and moves laterally to the right (as illustrated in FIG. 1). The PNP head 40 passes over the scanner 52, which inspects the electrical parts 24 picked up by the PNP head 40. The scanner 52 then relays information to the CPU 56 regarding the presence and absence of the electrical parts 24, and if any of the electrical parts 24 are unacceptable. While the PNP head 40 is moving laterally, the pivotal coupling 48 rotates the PNP head 40 about 90-degrees in either a clockwise or counter-clockwise direction. The actuating mechanisms 164 are then actuated to move the vacuum rails 124 to the minimum pitch to match the spacing within the columns of the vacuum nozzles 176 (in other words, the spacing between vacuum nozzles in adjacent vacuum rails) with the spacing between compartments 76 of the carrier tape 36. Upon moving the vacuum rails 124 to the minimum pitch and positioning the PNP head 40 over the carrier tape 36, the PNP head 40 is in the placing position 88.

The CPU 56 communicates with the solenoids 240 to indicate how the PNP head 40 will populate the carrier tape 36 with the electrical parts 24. Those solenoids 240 associated with empty vacuum nozzles 176 (missing electrical parts) can supply vacuum, low pressure air, or no air to the vacuum nozzles 176. Those solenoids 240 associated with unacceptable electrical parts 24 will maintain the supply of vacuum to the vacuum nozzles 176 to ensure that the unacceptable electrical parts 24 are not placed into the compartments 76 of the carrier tape 36. Those solenoids 240 associated with acceptable electrical parts 24 switch the vacuum nozzles 176 from vacuum to either low pressure air or no air when the vacuum nozzles 176 are positioned over the compartments 76.

To switch the vacuum nozzles 176 to low pressure, the CPU 56 sends a signal to the solenoids 240 to fluidly connect the low pressure air ports 252 and the supply ports 256, which fluidly connect the low pressure air supply channel 192 to the vacuum nozzles 176 via the vertical low pressure air channels 200, the low pressure air apertures 208, the low pressure air ports 250, the supply ports 256, the supply apertures 212, the apertures 228 defined in the vacuum mounting plate 216, the air tube couplings 236, and the air tubes 232. To switch the vacuum nozzles 176 to no air, the CPU 56 sends a signal to the solenoids 240 to fluidly connect the supply ports 256 with neither of the vacuum ports 248 or the low pressure air ports 252. This prevents both vacuum and low pressure air from being supplied to the vacuum nozzles 176. Switching the vacuum nozzles 176 to low pressure air or no air will blow or drop the electrical parts 24, respectively, into the compartments 76.

The first column of vacuum nozzles 176 is positioned over the compartments 76 of the carrier tape 36 and the PNP head 40 moves downward toward the carrier tape 36. A signal is sent from the CPU 56 to the drive mechanism of the carrier tape 36 and determines operation of the drive mechanism. The signal includes information regarding missing electrical parts 24 and unacceptable electrical parts 24 that may be vacuumly secured to the vacuum nozzles 176. The drive mechanism drives the carrier tape 36 forward and backward underneath the first column of vacuum nozzles 176 to position empty compartments 76 under the vacuum nozzles 176 associated with good electrical parts 24. The forward and backward movement of the carrier tape 36 ensures that all empty compartments 76 are positioned underneath a vacuum nozzle associated with a good electrical part 24 and that all the compartments 76 of the carrier tape 36 are filled. For the sake of an example of the placing operation, assume that the third vacuum nozzle 176 in the first column of the vacuum nozzles 176 has a unacceptable electrical part 24 vacuumly secured thereto or is missing a good part that should be there and the remainder of the vacuum nozzles 176 in the first column have good electrical parts 24 present. In this case, the first and second vacuum nozzles 176 would blow or drop their respective good electrical parts 24 into the compartments 76 positioned therebelow and the third vacuum nozzle 176 would not blow or drop its respective unacceptable electrical part 24. The drive mechanism would then advance the carrier tape 36 to position the compartment 76 that was below the third vacuum nozzle 176 to a position below the fourth vacuum nozzle 176. The fourth, fifth, and sixth vacuum nozzles 176 then drop their respective good electrical parts 24 into the compartments 76 positioned therebelow.

While the PNP head 40 is placing good electrical parts 24 from the first column of the PNP head 40 into the compartments 76 of the carrier tape 36, the solenoids 240 associated with the vacuum nozzles 176 in the second and third columns all maintain the supply of vacuum to their respective vacuum nozzles 176. Once the parts of the first column are placed, the PNP head 40 moves laterally via the linear actuator 44 to position the second column of vacuum nozzles 176 and electrical parts 24 over the empty compartments 76 of the carrier tape 36. The above-described placing process is then repeated for the second column while the solenoids 240 associated with the vacuum nozzles 176 in the third column maintain the supply of vacuum to their respective vacuum nozzles 176. Then the process is repeated for the third column.

Electrical parts 24, and especially the very small ones, sometimes build up electric static and cling to vacuum nozzles 176. In this circumstance, it is helpful to use the low pressure air rather than no air when placing the electrical parts 24 in the compartments 76. The low pressure air is also helpful when placing large electrical parts 24 to ensure the electrical parts 24 are placed flat in the bottoms of the compartments 76.

After placing all the acceptable electrical parts 24 into the carrier tape 36, the PNP head 40 rotates back to its original orientation in either a clockwise or counter-clockwise direction. The vacuum rails 124 then move to the maximum pitch to match the spacing between compartments of the reject tray 60. The PNP head 40 moves laterally to the left (as shown in FIG. 1) until it is in a position to deposit unacceptable electrical parts 24 into the compartments 100 of the reject tray 60. The reject tray 60 moves along the path 104 to position empty compartments 100 under the vacuum nozzles 176 containing unacceptable electrical parts 24. The PNP head 40 and reject tray 60 operate in a manner similar to that of the PNP head 40 and carrier tape 36 (during the placement of electrical parts 24 into the carrier tape 36) to place all unacceptable electrical parts 24 in the reject tray 60 and fill all the compartments 100. After placing all electrical parts 24 in either the carrier tape 36 or the reject tray 60, the apparatus 20 is ready to repeat the process and perform another cycle.

The PNP head 40 does not necessarily have to be in the minimum and maximum pitches as described above with respect to the operation of the apparatus 20. For example, the PNP head 40 can be in the minimum pitch when picking up (the picking position) electrical parts 24 from the input tray 28. In this example, the spacing between compartments of the input tray 28 would be complementary to the spacing between vacuum nozzles 176 in the minimum pitch of the PNP head 40. Also for example, the PNP head 40 can be in the minimum pitch when placing unacceptable parts 24 in the reject tray 60. In this example, the spacing between compartments of the reject tray 60 would be complementary to the spacing between vacuum nozzles 176 in the minimum pitch of the PNP head 40. Further for example, the PNP head 40 can be in the maximum pitch when placing electrical parts 24 into the compartments 76 of the carrier tape 36. In this example, the spacing between the compartments 76 of the carrier tape 36 would be complementary to the spacing between the vacuum nozzles 176 in the maximum pitch of the PNP head 40.

The steps of the operation of the apparatus 20 as described above do not necessarily have to occur in the order described. For example, the PNP head 40 can rotate via the pivotal coupling 48 at anytime after the PNP head 40 picks up the electrical components 24 from the input tray 28 and before the PNP head 40 places the electrical parts 24 in the carrier tape 36. Also for example, the vacuum rails 124 can be moved to the minimum pitch anytime after the PNP head 40 picks up the electrical parts 24 from the input tray 28 and before the PNP head 40 places the electrical parts 24 in the carrier tape 36. Further for example, the PNP head 40 can place unacceptable electrical parts 24 in the reject tray 60 prior to placing the electrical parts 24 in the carrier tape 36. In this instance, the PNP head 40 would have to rotate some time after placing the unacceptable electrical parts 24 in the reject tray 60 and some time prior to placing the electrical parts 24 in the carrier tape 36.

Referring to FIG. 16, an alternative construction of a portion of the apparatus 20 is illustrated and includes numerous rows of carrier tape 36 positioned parallel to one another. In this alternative construction, the apparatus 20 includes three rows of carrier tape 36, or another number equal to the columns of the vacuum nozzles 176. By having equal number of carrier tape rows and vacuum nozzle columns, acceptable electrical parts 24 from all columns of vacuum nozzles 176 can be placed into respective carrier tapes all at once rather than placing acceptable electrical parts 24 in the carrier tape 36 one column at a time (as discussed above).

Each row of carrier tape 36 can be driven independently from one another by the same driving mechanism or each row of carrier tape 36 can be driven by an independent driving mechanism that advances and retreats the carrier tape 36 according to the signals received from the CPU 56. Having various rows of carrier tape 36 can increase the speed at which electrical parts 24 are packaged in carrier tapes 36. Likewise, advancing the rows of carrier tape 36 independently from one another can increase the speed at which electrical parts are packaged in the carrier tapes 36.

Although particular constructions of the present invention have been shown and described, other alternative constructions will be apparent to those skilled in the art and are within the intended scope of the present invention.

1. A pick-and-place apparatus comprising:
a frame;
a plurality of vacuum rails adapted for communication with a source of vacuum, the rails being movable in the frame with respect to each other;
a row of vacuum nozzles on each vacuum rail, the space between nozzles on the same vacuum rail defines a first pitch and the space between nozzles on different vacuum rails defines a second pitch that is adjustable between maximum and minimum settings by moving the vacuum rails with respect to each other;
a first mechanism for moving the vacuum rails apart toward a maximum second pitch; and
a second mechanism for moving the vacuum rails toward a minimum second pitch.

2. The pick-and-place apparatus of claim 1, wherein the frame includes a pair of generally parallel slots supporting opposite ends of the vacuum rails, and wherein the vacuum rails are movable in the frame by sliding within the slots.

3. The pick-and-place apparatus of claim 1, further comprising a plurality of stop members against which the vacuum rails abut under influence of the first mechanism to define the maximum second pitch.

4. The pick-and-place apparatus of claim 3, wherein each stop member is adjustable independently from the other stop members to selectively modify the position of each vacuum rail in its own maximum second pitch independently of the other vacuum rails.

5. The pick-and-place apparatus of claim 4, wherein the plurality of stop members comprises a plurality of eccentric pins that are selectively rotatable to adjust the maximum second pitch of corresponding vacuum rails.

6. The pick-and-place apparatus of claim 1, wherein the vacuum rails are movable into abutment with each other to define the minimum second pitch.

7. The pick-and-place apparatus of claim 1, wherein the first mechanism comprises a plurality of biasing members positioned between adjacent vacuum rails for biasing the vacuum rails apart toward the maximum second pitch.

8. The pick-and-place apparatus of claim 1, wherein the first mechanism comprises a plurality of compressed coil springs positioned between adjacent vacuum rails for biasing the vacuum rails toward the maximum second pitch.

9. The pick-and-place apparatus of claim 1, wherein the second mechanism comprises a plurality of pneumatic cylinders.

10. The pick-and-place apparatus of claim 9, wherein the pneumatic cylinders act on the outermost rails and move the outermost rails toward each other.

11. The pick-and-place apparatus of claim 1, wherein one of the vacuum rails is fixed within the pick-and-place apparatus and maintains its position in both the minimum and maximum second pitches.

12. The pick-and-place apparatus of claim 1, further comprising a vacuum and air manifold and a plurality of solenoids, wherein the vacuum and air manifold are operatively connected to each vacuum nozzle to selectively provide vacuum and low pressure air to each nozzle, and wherein the plurality of solenoids are operable to control which of vacuum or low pressure air is supplied to each nozzle.

13. The pick-and-place apparatus of claim 1, wherein the frame comprises a manifold defining a plurality of manifold apertures therein adapted for communication with the source of vacuum, the pick-and-place apparatus further comprising a plate and a plurality of tubes, the plate being connected to the manifold and defining a plurality of plate apertures therethrough alignable with a selected group of the manifold apertures, the plate covering and sealing all manifold apertures except the selected group of manifold apertures, wherein each of the tubes is connected between one of the vacuum nozzles and one of the plate apertures to fluidly communicate the vacuum nozzles with the source of vacuum.

14. The pick-and-place apparatus of claim 13, further comprising a plug insertable into one of the plate apertures aligned with one of the manifold apertures and not having a tube connected thereto for preventing vacuum from escaping from the plate aperture.

15. The pick-and-place apparatus of claim 13, wherein the plurality of vacuum rails, the rows of vacuum nozzles, the plate, and the plurality of tubes comprise a first changeout assembly, the pick-and-place apparatus further comprising a second changeout assembly comprising vacuum rails, vacuum nozzles, a plate defining a plurality of plate apertures therethrough, and a plurality of tubes connected between the vacuum nozzles and the plate apertures; wherein the number of rails, nozzles, tubes, and plate apertures in the second changeout assembly is different from the number in the first changeout assembly; and wherein the first changeout assembly and the second changeout assembly are interchangeably connected within the pick-and-place apparatus.

16. The pick-and-place apparatus of claim 1, wherein the frame comprises a manifold defining a plurality of vacuum apertures adapted for communication with the source of vacuum, a plurality of air apertures adapted for communication with a source of air, and a plurality of supply apertures fluidly communicatable with the vacuum apertures and the air apertures, the pick-and-place apparatus further comprising a plate and a plurality of tubes, wherein the plate is connected to the manifold and defines a plurality of plate apertures therethrough alignable with a selected group of the manifold apertures, the plate covering and sealing all the manifold apertures except the selected group of manifold apertures, and wherein each of the tubes is connected between one of the vacuum nozzles and one of the plate apertures to fluidly communicate the vacuum nozzles with the source of vacuum and the source of air.

17. The pick-and-place apparatus of claim 16, further comprising a plurality of solenoids for selectively controlling fluid communication of the vacuum nozzles with either the source of vacuum or the source of air, wherein each solenoid is in fluid communication with one of the vacuum apertures, one of the air apertures, and one of the supply apertures to selectively control fluid communication of the supply aperture with either the corresponding vacuum aperture or the corresponding air aperture, thereby selectively controlling fluid communication of the corresponding vacuum nozzle with either the source of vacuum or the source of air.

18. An apparatus for packaging electrical parts, the apparatus comprising:
a pick-and-place head including a frame, a plurality of vacuum rails movable in the frame with respect to each other and adapted for communication with a source of vacuum, and a row of vacuum nozzles on each vacuum rail, the space between nozzles on the same vacuum rail defines a first pitch and the space between nozzles on different vacuum rails defines a second pitch that is adjustable between a maximum second pitch and a minimum second pitch by moving the vacuum rails with respect to each other;
a rotatable coupling engagable with the pick-and-place head to rotate the pick-and-place head; and
an actuator operably connected to the pick-and-place head to move the pick-and-place head between a picking position, in which the pick-and-place head picks up electrical parts from a first electrical part support, and a placing position, in which the pick-and-place head places electrical parts in a second electrical part support;
wherein the pick-and-place head is rotatable by the rotatable coupling between the picking position and the placing position.

19. The apparatus of claim 18, wherein the first electrical part support comprises an electrical part tray and the second electrical part support comprises carrier tape.

20. The apparatus of claim 18, wherein the pick-and-place head is rotatable about 90 degrees between the picking position and the placing position.

21. The apparatus of claim 18, wherein one of the vacuum rails is fixed within the frame and maintains the same position within the frame when the vacuum rails are in both the minimum and maximum second pitches.

22. The apparatus of claim 18, wherein the pick-and-place head further includes a plurality of compression springs and a plurality of pins, the plurality of compression springs being positioned between adjacent vacuum rails to bias the vacuum rails toward the maximum second pitch, each of the pins is engagable by one of the vacuum rails to limit travel of the vacuum rails under influence of the springs and to position the vacuum rails in the maximum second pitch.

23. The apparatus of claim 22, wherein each of the plurality of pins is adjustable independently from the other plurality of pins to selectively adjust the maximum second pitch of the corresponding vacuum rail independently of the other vacuum rails.

24. The apparatus of claim 23, wherein each of the plurality of pins is eccentric and selectively rotatable to adjust the maximum second pitch of the corresponding vacuum rail independently of the other vacuum rails.

25. The apparatus of claim 22, wherein the pick-and-place head further includes an actuating mechanism for overcoming the bias of the springs and moving the vacuum rails into the minimum second pitch.

26. A method of operating a pick-and-place apparatus, the method comprising:
picking up a two-dimensional array of electrical parts from a first electrical part support with the pick-and-place apparatus, the two-dimensional array of electrical parts being arranged in rows and columns;
changing spacing between the rows; and
placing the electrical parts in a second electrical part support one column at a time.

27. The method of claim 26, further comprising rotating the pick-and-place apparatus about 90 degrees after picking and before placing the electrical parts.

28. The method of claim 26, wherein the second electrical part support is carrier tape, the method further comprising advancing the carrier tape after each column of electrical parts is placed therein.

29. The method of claim 26, further comprising scanning the electrical parts between picking and placing the electrical parts to identify unacceptable electrical parts.

30. The method of claim 29, further comprising placing unacceptable electrical parts in a reject tray separate from the first and second electrical part supports.

31. The method of claim 30, wherein placing unacceptable electrical parts includes placing unacceptable electrical parts before placing the electrical parts in a second electrical part support.

32. The method of claim 30, wherein placing unacceptable electrical parts includes placing unacceptable electrical parts after placing the electrical parts in the second electrical part support.

33. The method of claim 26, wherein the first electrical part support is a tray operable to support electrical parts in rows and column and the second electrical part support is carrier tape.

34. The method of claim 26, wherein the pick-and-place apparatus includes a plurality of vacuum rails and a row of vacuum nozzles on each vacuum rail adapted for communication with a source of vacuum for picking up the two-dimensional array of electrical parts, each row of vacuum nozzles on the same vacuum rail being operable to pick up the rows of the two-dimension array of electrical parts and corresponding vacuum nozzles on different vacuum rails being operable to pick up the columns of the two-dimensional array of electrical parts, the method further comprising interchanging the plurality of vacuum rails and the rows of vacuum nozzles with a second plurality of vacuum rails and a row of second vacuum nozzles on each of the second plurality of vacuum rails, wherein the second vacuum nozzles are adapted for communication with the source of vacuum for picking up a different two-dimensional array of electrical parts.

35. The method of claim 26, wherein the pick-and-place apparatus includes a manifold defining a plurality of manifold apertures therein that are adapted for communication with a source of vacuum and a first changeout assembly including a plate defining a plurality of plate apertures therein that are alignable with a selected group of the manifold apertures, a plurality of vacuum rails, a row of vacuum nozzles on each vacuum rail for picking up the two-dimensional array of electrical parts, and a plurality of tubes connected between the vacuum nozzles and the plate apertures, wherein the plate covers and seals the manifold apertures except the selected group of manifold apertures, and wherein the vacuum nozzles are in fluid communication with the source of vacuum through the tubes, the plate apertures and the manifold apertures, the method further comprising interchanging the first changeout assembly with a second changeout assembly including a plate defining a plurality of plate apertures therethrough that are alignable with a selected group of manifold apertures, vacuum rails, vacuum nozzles, and a plurality of tubes connected between the vacuum nozzles and the plate apertures; wherein the number of vacuum rails, vacuum nozzles, tubes, and plate apertures in the second changeout assembly is different from the number in the first changeout assembly and the number of manifold apertures in the selected group of the second changeout assembly is different than the number of manifold apertures in the selected group of the first changeout assembly; and wherein the vacuum nozzles in the second changeout assembly pick up a different two-dimensional array of electrical parts than the vacuum nozzles in the first changeout assembly and are in fluid communication with the source of vacuum through the plurality of tubes and the plate apertures of the second changeout assembly and the manifold apertures of the manifold.

36. The method of claim 35, further comprising inserting a plug into one of the plate apertures defined in the plate of either the first or second changeout assembly that is aligned with one of the manifold apertures in the selected group and not having a tube connected thereto, the plug preventing vacuum from escaping out of the plate aperture.

37. The method of claim 26, wherein the pick-and-place apparatus includes a manifold defining a plurality of vacuum apertures adapted for communication with a source of vacuum, a plurality of air apertures adapted for communication with a source of air, and a plurality of supply apertures fluidly communicatable with the vacuum apertures and the air apertures, the pick-and-place apparatus further includes a first changeout assembly including a plate defining a plurality of plate apertures therein that are alignable with a selected group of the supply apertures, a plurality of vacuum rails, a row of vacuum nozzles on each vacuum rail for picking up the two-dimensional array of electrical parts, and a plurality of tubes connected between the vacuum nozzles and the plate apertures, wherein the vacuum nozzles are in fluid communication with either the source of vacuum or the source of air through the tubes, the plate apertures, the supply apertures, and either the vacuum apertures or the air apertures, respectively, the method further comprising interchanging the first changeout assembly with a second changeout assembly including a plate defining a plurality of plate apertures therein alignable with a selected group of the supply apertures, vacuum rails, vacuum nozzles, and a plurality of tubes connected between the vacuum nozzles and the second plate apertures of the second changeout assembly; wherein the number of vacuum rails, vacuum nozzles, tubes, and plate apertures in the second changeout assembly is different from the number in the first changeout assembly and the number of supply apertures in the selected group of the second changeout assembly is different than the number of supply apertures in the selected group of the first changeout assembly; and wherein the vacuum nozzles in the second changeout assembly pick up a different two-dimensional array of electrical parts than the vacuum nozzles in the first changeout assembly and are in fluid communication with either the source of vacuum or the source of air through the plurality of tubes and the plate apertures of the second changeout assembly and the supply apertures and either the vacuum apertures or the air apertures, respectively, of the manifold.

38. The method of claim 26, wherein the pick-and-place apparatus includes a manifold defining a plurality of vacuum apertures adapted for communication with a source of vacuum, a plurality of air apertures adapted for communication with a source of air, and a plurality of supply apertures fluidly communicatable with the vacuum apertures and the air apertures, the pick-and-place apparatus further includes a plate defining a plurality of plate apertures therein that are alignable with a selected group of the supply apertures, a plurality of vacuum rails, a row of vacuum nozzles on each vacuum rail for picking up the two-dimensional array of electrical parts, a plurality of tubes connected between the vacuum nozzles and the plate apertures, the vacuum nozzles being in fluid communication with either the source of vacuum or the source of air through the tubes, the plate apertures, the supply apertures, and either the vacuum apertures or the air apertures, respectively, the method further comprising selectively controlling fluid communication of the vacuum nozzles with either the source of vacuum or the source of air with a plurality of solenoids, wherein each solenoid is in fluid communication with one of the vacuum apertures, one of the air apertures, and one of the supply apertures to selectively control fluid communication of the supply aperture with either the corresponding vacuum aperture or the corresponding air aperture, thereby selectively controlling fluid communication of the corresponding vacuum nozzle with either the source of vacuum or the source of air.

39. A method of operating a pick-and-place apparatus, the method comprising:
providing the pick-and-place apparatus that includes a plurality of vacuum rails movable relative to each other and adapted for communication with a source of vacuum, a row of vacuum nozzles are on each vacuum rail, the space between nozzles on the same vacuum rail defines a first pitch and the space between nozzles on different vacuum rails defines a second pitch that is adjustable between maximum and minimum settings by moving the vacuum rails with respect to each other;
picking up a two-dimensional array of electrical parts with the vacuum nozzles of the pick-and-place apparatus from a first electrical part support;
adjusting the second pitch of the vacuum rails;
rotating the pick-and-place apparatus and the two-dimensional array of electrical parts; and
placing the electrical parts in a second electrical part support.

40. The method of claim 39, wherein rotating includes rotating the pick-and-place apparatus and the two-dimensional array of electrical parts about 90 degrees after picking and before placing the electrical parts.

41. The method of claim 39, further comprising scanning the electrical parts between picking and placing the electrical parts to identify unacceptable electrical parts.

42. The method of claim 41, further comprising placing unacceptable electrical parts in a reject tray separate from the first and second electrical part supports.

43. The method of claim 42, wherein placing unacceptable electrical parts includes placing unacceptable electrical parts before placing electrical parts in the second electrical part support.

44. The method of claim 42, wherein placing unacceptable electrical parts includes placing unacceptable electrical parts after placing electrical parts in the second electrical part support.

45. The method of claim 39, wherein the first electrical part support is a tray operable to support electrical parts in rows and columns and the second electrical part support is carrier tape.
